(19) United States
(12) Patent Application Publication
(10) Pub. No.: US 2004/0193080 A1
(43) Pub. Date: Sep. 30, 2004

(54) Vibrator assembly with adaptor coupling

(75) Inventor: Anjani Siddhartha, Sunland, CA (US)

Correspondence Address: Walter W. Duft, Suite 10, 10255 Main Street, Clarence, NY, 14031, US

(73) Assignee: Health Devices Corporation

(21) Appl. No.: 10/395,863

(22) Filed: Mar. 24, 2003

(51) Int. Cl. A61H 23/02

(52) U.S. Cl. 601/72; 601/135

(57) ABSTRACT

A vibrator assembly comprises a control handle, a vibrator body, and an adaptor coupling. The adaptor coupling is adapted to interconnect the control handle and the vibrator body. The control handle and the vibrator body are not designed for direct interconnection to each other. Thus, the adaptor coupling enhances the versatility of the control handle and the vibrator body by allowing them to be used together. By employing a set of adaptor couplings, the control handle can be used with a set of vibrator bodies of different size or shape, with adaptor coupling being selectively useable to interconnect the control handle to the vibrator bodies on an interchangeable basis.

### BACKGROUND OF THE INVENTION

1. Field of the Invention

This invention relates to electric vibrators, including therapeutic massage devices and dildos.

2. Description of the Prior Art

By way of background, electric vibrators have been used for therapeutic muscle relaxation purposes and also for sexual pleasure by individuals and couples alike. An electric vibrator typically comprises an oblong plastic or rubber body having a hollow area therein formed in a molding process. A vibrating motor device is disposed within the hollow area for producing vibrational pulses that pass through the vibrator body. Electrical power is provided by batteries that in some designs are incorporated directly into the vibrator body along with one or more control switch elements. The base of the vibrator has a removable end cap to allow access to the batteries. In other designs the control switch elements are incorporated in a separate control unit that is in the form of a handle affixed to the base of the vibrator body. The control unit is detachable so as to allow access to the batteries.

Vibrators of the foregoing type are available in many shapes and sizes depending on the body location to be vibrated and the vibrating sensation to be attained. Acquiring a collection of such vibrators can be expensive, particularly when the vibrators are of the type that include a vibrator control unit. In such cases, the vibrator control unit is normally designed to mount only the vibrator body it is sold with, and will not accommodate vibrator bodies of different size and mounting configurations. Thus, a person who desires a particular vibrator body must settle for the control unit that comes with that vibrator body. This is disadvantageous because such persons may feel they are needlessly being required to purchase duplicate control unit equipment. A further disadvantage is that a user may have a preference for a particular control unit, but cannot use that device with more than one vibrator body. Additionally, there are also persons that are new users and prefer to start with a slim vibrator body and move to a thicker vibrator body when comfortable and ready for a different sensation.

As stated, there are different vibrators for vibrating different body locations or attaining different vibrating sensations. Vibrator fanciers who maintain collections of such vibrators desire the freedom to select a device of choice depending on their mood and the exigencies of the moment. For example, a person may initially wish to have an external body location stimulated, but may subsequently desire to vibrate sexually sensitive areas of the body. In accordance with the prior art, separate and self-contained vibrator products of various size and shape are needed to accommodate the needs of the users, resulting in the disadvantages mentioned above.

Accordingly, it would be desirable to provide a vibrator whose capabilities are not limited in the manner described above. What is needed is a vibrating device or system that includes a control handle which is useable with more than one vibrator body. Such a device or system would allow the selection of different vibrator bodies based on the user's desires at a particular moment (i.e. body location to be vibrated and the vibrating sensation to be attained), with the vibrator bodies all being useable with the same control handle on an interchangeable basis.

### SUMMARY OF THE INVENTION

The foregoing problems are solved and an advance in the art is obtained by a novel vibrator assembly that comprises a control handle, a vibrator body, and an adaptor coupling adapted to removably interconnect to the control handle and the vibrator body.

The control handle and vibrator body are conventional in design. The adaptor coupling comprises an adaptor body having a control handle end, a vibrator body end, a first coupling portion extending from the control handle end, and a second coupling portion extending from the vibrator body end. The adaptor body can be annular in shape so as to have a central opening extending between the control handle end and the vibrator body end. In some cases a solid generally cylindrical body could also be used. The first coupling portion is adapted to removably connect to the control handle. The second coupling portion is adapted to removably connect to the vibrator body. Both coupling portions preferably comprise rotatable coupling configurations, such as threads, or a twist interlock arrangement, for respectively engaging the mountable end portions of the control handle and the vibrator body.

Use of the adaptor coupling enables a normally incompatible vibrator body and control handle to be used together. The invention further contemplates the use of multiple additional adaptor couplings adapted to removably connect to the control handle and to multiple respective vibrator bodies of varying size and configuration. By selecting the appropriate adaptor coupling, vibrator bodies with almost any type of base end configuration can be used with a single control handle.

### BRIEF DESCRIPTION OF THE DRAWINGS

The foregoing and other features and advantages of the invention will be apparent from the following more particular description of preferred embodiments of the invention, as illustrated in the accompanying Drawings, in which:

FIG. 1 is an exploded view of a prior art detachable control handle and vibrator body, and an exploded view of an alternative prior art vibrator body and end cap;

FIG. 2A is a side view of the control handle of FIG. 1;

FIG. 2B is a bottom view of the control handle of FIG. 1;

FIG. 2C is a cross-sectional center line view of the control handle of FIG. 1 and a side view of the vibrator body of FIG. 1;

FIG. 3 is an exploded view of a vibrator assembly in accordance with the invention comprising an adaptor coupling, the control handle of FIG. 1, and one of the vibrator bodies of FIG. 1;

FIG. 4A is a perspective view of the adaptor coupling of FIG. 2;

FIG. 4B is a cross-sectional center line view of the adaptor coupling of FIG. 2;

FIG. 5A is a cross-sectional center line view of an alternative adaptor coupling constructed in accordance with the invention;

FIG. 5B is a cross-sectional center line view of another alternative adaptor coupling constructed in accordance with the invention;

FIG. 5C is a cross-sectional center line view of another alternative adaptor coupling constructed in accordance with the invention; and

FIG. 5D is a cross-sectional center line view of another alternative adaptor coupling constructed in accordance with the invention.

### DETAILED DESCRIPTION OF THE PREFERRED EMBODIMENT

The features and advantages of the present invention will now be presented by way of exemplary embodiments shown by the drawing figures, in which like reference numerals indicate like elements in all of the several views.

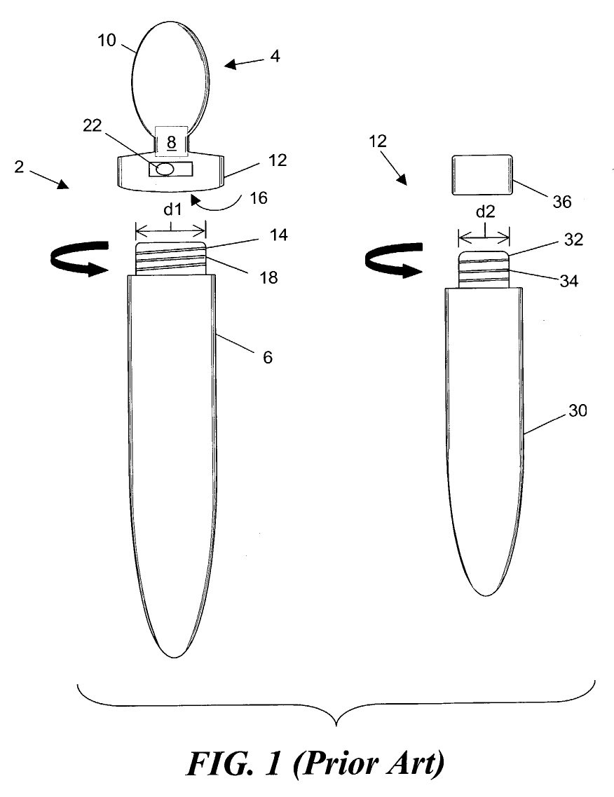

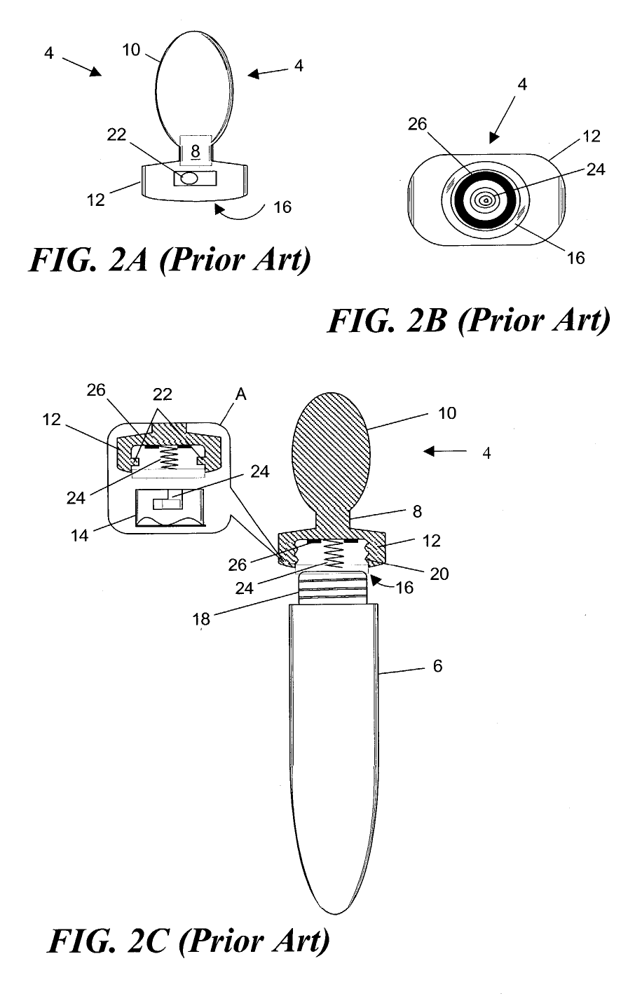

Before describing the invention in more detail, it will be instructive to briefly review the designs of two conventional vibrator units as found in the prior art. FIG. 1 shows two such prior art designs 2 and 12, one with a control handle and one without. The conventional vibrator assembly 2 is shown to include a vibrator control handle 4 and a vibrator body 6. The control handle 4 is constructed as a body 8 (made from plastic or other suitable material) that defines a handle end portion 10 and the vibrator receiving end portion 12. The handle end portion 10 is generally bulbous, with a conventional handle shape adapted for holding or gripping by a hand. The vibrator receiving end 12 of the control handle 4 is adapted to receive a mountable base end 14 of the vibrator body 6. As can be seen with additional reference to FIGS. 2A-2C, the vibrator body's base end 14 is received in a vibrator receiving opening 16 of the control handle's vibrator receiving end 12. The vibrator base end 14 has a diameter d1 that matches the size of the vibrator receiving opening 16. Both the vibrator base end 14 and the vibrator receiving opening 16 are constructed with a conventional rotatable coupling configuration, namely threads. In particular, the vibrator base end 14 has a male thread pattern 18, while the vibrator receiving opening 16 has a corresponding female thread pattern 20.

In use, the vibrator body 6 is attached to the control handle 4 by rotating the vibrator base end 14 relative to the vibrator receiving opening 16 to interengage the respective thread patterns 18 and 20 on each component. Rotating the components in the reverse direction allows the control handle 4 to be separated from the vibrator body 6 for access to the batteries (not shown) that are conventionally housed within the vibrator body.

Note that various alternative rotatable coupling configurations may be conventionally employed to interconnect the control handle 4 and the vibrator body 6. These include the “twist interlock” configuration shown in inset A of FIG. 2C. In this alternative configuration, there will typically be two opposing tabs 22 formed in the vibrator receiving opening 16 for engaging two slots 24 formed on the vibrator base end 14.

It will also be seen that the vibrator receiving end 12 of the control handle 4 mounts an electrical power switch 22 that controls the operation of the vibrator body 6 via electrical connections to thereto. In particular, at the bottom of the vibrator receiving opening 16 there is mounted a spring-shaped (negative) contact connector 24 and a ring-shaped (positive) contact connector 26. The contact connector 24 is adapted to engage the negative terminal of a battery housed within the vibrator body 6. The contact connector 26 is adapted to engage a terminal (not shown) that connects to the positive terminal of the same battery, or another battery connected in series with the first battery.

Returning now to FIG. 1, the second conventional vibrator 12 shown therein is designed for use without a control handle. It includes a vibrator body 30 with a base end 32. An opening (not shown) in the vibrator base end 32 receives one or more batteries (not shown) into the interior of the vibrator body 30. The vibrator base end 32 is also formed with a male thread pattern 34. An end cap 36 mounts over the vibrator base end 32 to retain the batteries, and has a female thread pattern (not shown) that matches the male thread pattern 34 of the vibrator base end. Note that various alternative rotatable coupling configurations may be conventionally employed to interconnect the end cap 36 to the vibrator base end 32. These could include a “twist interlock” configuration of the type shown in inset A of FIG. 2C.

It will be seen that the vibrator body 30 cannot be mounted on the control handle 4 due to a size mismatch, i.e., the vibrator base end 32 has a diameter d2 which is too small for the control handle's vibrator receiving opening 16. This situation results in the disadvantages outlined by way of background above.

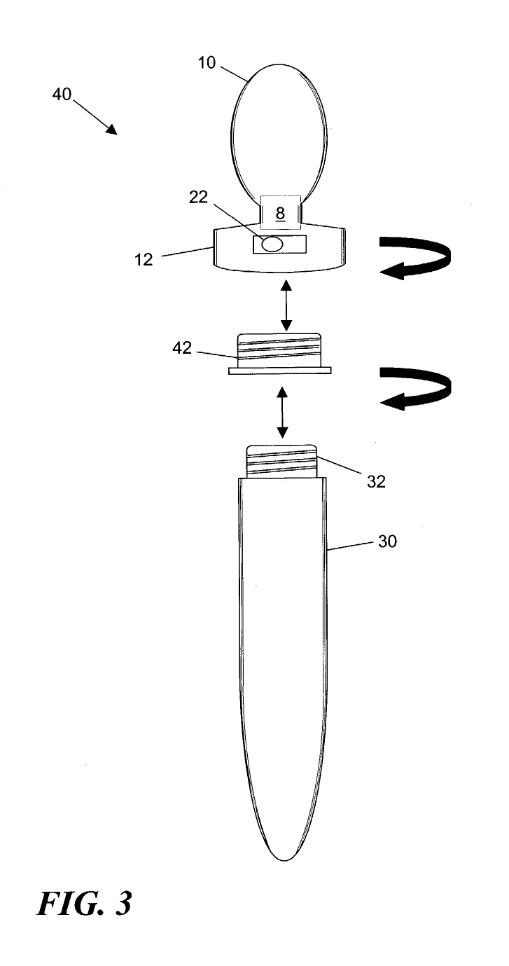

Turning now to FIG. 3, a vibrator assembly 40 constructed in accordance with the principles of the present invention solves this dilemma by providing a system for interconnecting the vibrator control handle 4 to the vibrator body 30 by way of an adaptor coupling 42. The primary function of the adaptor coupling 42 is to correct for the size mismatch between the control handle's vibrator receiving opening 16 and the vibrator base end 32. As shown by the arrows in FIG. 3, attachment of the adaptor coupling 42 to the control handle 4 is achieved by rotatably interconnecting one end of the adaptor coupling to the control handle's vibrator receiving end 12. Similarly, attachment of the adaptor coupling 42 to the vibrator body 30 is achieved by rotatably coupling the vibrator body base end 32 to the other end of the adaptor coupling 32.

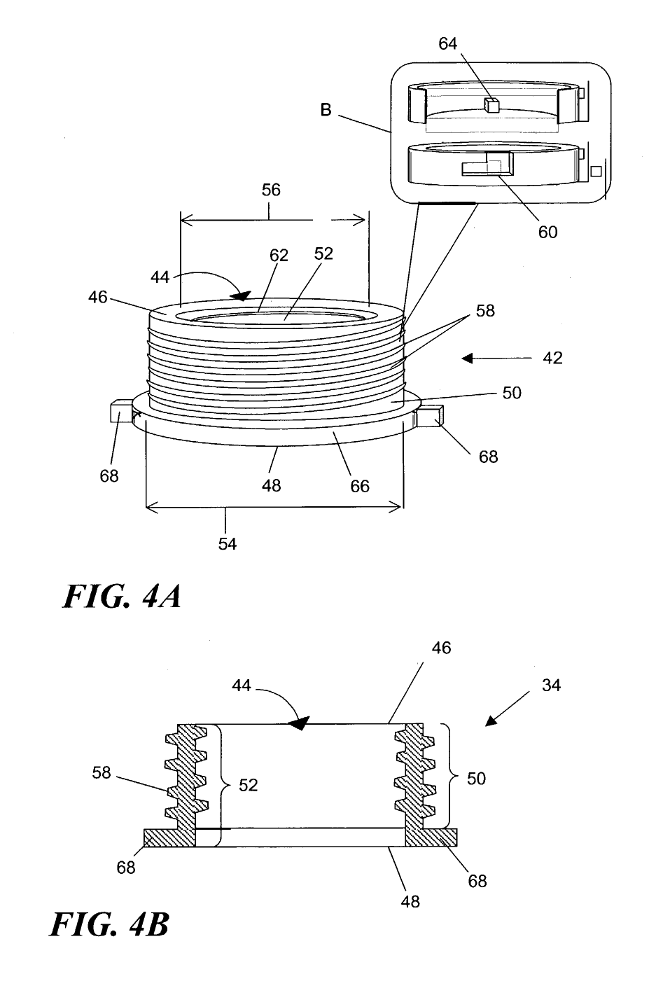

Turning now to FIGS. 4A and 4B, the adaptor coupling 42 is designed to accommodate the mounting configurations of both the vibrator control handle 4 and the vibrator body 30. In particular, the adaptor coupling 42, which can be made of plastic or other suitable material, and is formed in embodiment of FIGS. 4A and 4B as a generally annular body having a central opening 44, a control handle end 46, and a vibrator body end 48. As shown in FIG. 4B, the adaptor coupling 42 further includes a first coupling portion 50 and a second coupling portion 52. The first coupling portion 50 extends from the control handle end 46 and is adapted to couple to the control handle 4. The second coupling portion 52 extends from the vibrator body end 48 and is adapted to couple to the vibrator body 30.

The adaptor coupling 42 is further characterized by the first coupling portion 50 being formed on an outside portion of the adaptor coupling 42 and defined by an outside diameter 54 (see FIG. 4A). The outside diameter 54 is sized to be received in vibrator receiving opening 16 in the control handle 4. The adaptor coupling 40 is also characterized by the second coupling portion 52 being formed on an inside portion of the adaptor coupling that is defined within the opening 44 by an inside diameter 56 (see FIG. 4A). The inside diameter 56 is sized for receiving the vibrator base 32 of the vibrator body 30.

The first coupling portion 50 of the adaptor coupling 42 is constructed with a rotatable coupling configuration, namely a male thread pattern 58, that corresponds to the female thread pattern 20 formed on the vibrator receiving opening 16 of the control handle 4. Alternatively, a pair of “twist interlock” slots 60 (shown in inset B of FIG. 4A) could be used to engage the “twist interlock” tabs 22 shown in inset A of FIG. 2C. The second coupling portion 52 is also constructed with a rotatable coupling configuration, namely, a female thread pattern 62 that corresponds to the male thread pattern 34 on the vibrator base end 32. This coupling configuration could alternatively be implemented as a pair of “twist interlock” tabs 64 (shown in inset B of FIG. 4A) that engage optional corresponding “twist interlock” slots (not shown) on the vibrator base end 32, if the vibrator body 30 is so configured.

The vibrator body end 48 of the adaptor coupling 42 may further include a flange 66, having a diameter larger than the outside diameter 54, and a pair of tabs 68 adapted as handles for rotating the adaptor coupling 42 relative to the control handle 4.

As shown in FIG. 3, and as described above, it will be appreciated that the adaptor coupling 42 allows the vibrator body 30 can be quickly and securely attached to the control handle 4 for use, thereby increasing the versatility of the control handle beyond its conventional use with only the vibrator body 6 of FIG. 1. By extension of this concept, it will also be appreciated that additional adaptor couplings could be provided to further extend the capability of the control handle 4, with each adaptor coupling having a different vibrator mounting configuration to accommodate a variety of vibrator bodies of many different sizes.

A method is also contemplated by which a vibrator fancier can selectively employ vibrators from a collection of two or more vibrators, depending on mood or other circumstances. According to the method, a vibrator control handle of the type described herein is prepared for use with one of two vibrator bodies of different size and shape. These vibrators are respectively denominated the “first” and “second” vibrator bodies. Initially, the user is assumed to select the first vibrator body for use. If the second vibrator is already mounted on the control, it is removed. The first vibrator body may or may not be able to mount directly to the control handle. If it cannot, then an adaptor coupling having the requisite mounting configuration is selected for interconnecting the first vibrator body to the control handle. The adaptor coupling is connected to the control handle and also to the first vibrator body, and the assembly is ready for use. If it is subsequently desired to use the second vibrator body, the above procedure can be repeated.

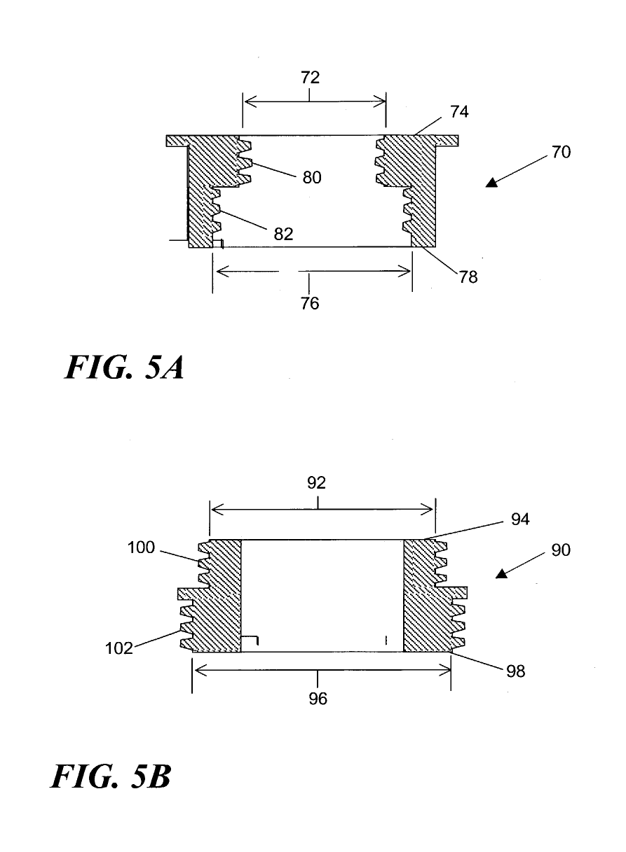

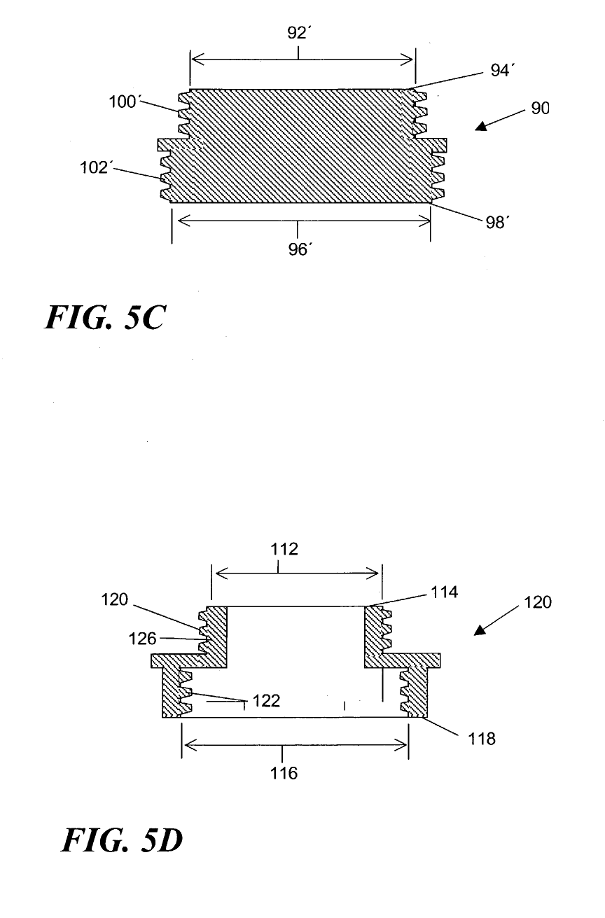

It should be understood that the adaptor coupling 32 will not always have the configuration of FIGS. 4A and 4B in which there is a male thread pattern to connect to the control handle 4 and a female thread pattern to connect to the vibrator body 20. On the contrary, adaptor couplings may be constructed to accommodate any desired handle- vibrator mounting scheme. As shown in FIG. 5A, for example, an adaptor coupling 70 is constructed as a generally annular body, but has no exterior coupling portion. Instead, the adaptor coupling 70 has a first coupling portion defined by a first inside diameter 72 extending from a first end 74, and a second coupling portion defined by a second inside diameter76 extending from a second end 78. The first inside diameter 72 is formed with a female thread pattern 80 and is sized for coupling to a control handle, and the second inside diameter 94 is formed with a female thread pattern 82 and is sized for coupling to a base end of a vibrator body, or visa versa.

In another alternative configuration shown in FIG. 5B, an adaptor coupling 90 is also constructed as an annular body, but has no interior coupling portion. Instead, the adaptor coupling 90 has a first coupling portion defined by a first outside diameter 92 extending from a first end 94, and a second coupling portion defined by a second outside diameter 96 extending from a second end 98. The first outside diameter 92 is formed with a male thread pattern 100 and is sized for coupling to a control handle, and the second outside diameter 96 is formed with a male thread pattern 102 and is sized for coupling to a base end of a vibrator body, or visa versa.

Note that the adaptor coupling 90 of FIG. 5B need not be a ring. Insofar as both coupling portions are on an outside surface of the coupling, its interior could be substantially solid so as to provide a generally cylindrical body, except that passageways “A” and “B” may be provided to allow electrical contact connectors (not shown) to pass therethrough. This configuration is shown by the adaptor coupling 90′ of FIG. 5C, which is otherwise identical to the adaptor coupling 90 as shown by the use of a corresponding set reference numerals 92′-102′.

In another alternative configuration shown in FIG. 5D, an adaptor coupling 110 is again constructed as a generally annular body and with outside and inside coupling portions. In particular, there is a first coupling portion defined by an outside diameter 112 extending from a first end 114, and a second coupling portion defined by an inside diameter 116 extending from a second end. The outside diameter 112 is formed with a male thread pattern 120 and is sized for coupling to a control handle, and the inside diameter 116 is formed with a female thread pattern 122 and is sized for coupling to a base end of a vibrator body, or visa versa. Note that the adaptor coupling 110 differs from the adaptor coupling 42 of FIGS. 4A-4B in that the outside diameter 112 is smaller than the inside diameter 116. In the adaptor coupling 42, the inside diameter 56 is smaller than the outside diameter 54.

It should be noted that any of the above-described adaptor couplings could be constructed so as to allow attachment when a control handle and vibrator body have different coupling configurations, such as a vibrator body configured with “twist interlock” tabs or slots mounting a control handle configured with a male or female thread pattern, and so on.

Accordingly, a vibrator assembly with an adaptor coupling has been disclosed. While various embodiments of the invention have been shown and described, it should be apparent that many variations and alternative embodiments could be implemented in accordance with the teachings herein. It is understood, therefore, that the invention is not to be in any way limited except in accordance with the spirit of the appended claims and their equivalents.

What is claimed is:

1. A vibrator assembly comprising:
a control handle;
a vibrator body; and
an adaptor coupling adapted to interconnect said control handle and said vibrator body.

2. A vibrator assembly in accordance with claim 1 wherein said adaptor coupling comprises:
a body;
a control handle end;
a vibrator body end;
a first coupling portion extending from said control handle end and adapted to removably connect to said control handle; and
a second coupling portion extending from said vibrator body end and adapted to removably connect to said vibrator body.

3. A vibrator assembly in accordance with claim 2 wherein said first and second coupling portions comprise rotatable coupling configurations.

4. A vibrator assembly in accordance with claim 3 wherein said rotatable coupling configurations comprise threads.

5. A vibrator assembly in accordance with claim 2 wherein said body is generally annular and said first coupling portion is defined by an outside diameter of said body and said second coupling portion is defined by an inside diameter of said body.

6. A vibrator assembly in accordance with claim 2 wherein said body is generally annular and said first and second coupling portions are defined by first and second inside diameters of said body.

7. A vibrator assembly in accordance with claim 2 wherein said body is generally annular and first and second coupling portions are defined by first and second outside diameters of said body.

8. A vibrator assembly in accordance with claim 2 wherein said body is generally annular and said first coupling portion is defined by an outside diameter of said body and said second coupling portion is defined by an inside diameter of said body, and wherein said outside diameter is less than said inside diameter.

9. A vibrator assembly in accordance with claim 2 wherein said body is generally annular and said first coupling portion is defined by an outside diameter of said body and said second coupling portion is defined by an inside diameter of said body, and wherein said outside diameter is greater than said inside diameter.

10. A vibrator assembly in accordance with claim 2 wherein said adaptor coupling further comprises a handle portion.

11. A vibrator assembly comprising:
a control handle;
a vibrator body;
an adaptor coupling having means for interconnecting said control handle and said vibrating body.

12. A vibrator assembly in accordance with claim 11 wherein said adaptor coupling comprises:
a body;
a control handle end;
a vibrator body end;
first coupling means associated with said control handle end for removably connecting to said control handle; and
second coupling means associated with said vibrator body end for removably connecting to said vibrator body.

13. A vibrator assembly in accordance with claim 12 wherein said first and second coupling means comprise rotatable couplings.

14. A vibrator assembly in accordance with claim 13 wherein said rotatable coupling means comprise threads.

15. A vibrator assembly in accordance with claim 12 wherein said body is generally annular and said first coupling means is defined by an outside diameter of said body and said second coupling means is defined by an inside diameter of said body.

16. A vibrator assembly in accordance with claim 12 wherein said body is generally annular and said first and second coupling means are defined by first and second inside diameters of said body.

17. A vibrator assembly in accordance with claim 12 wherein said body is generally annular and first and second coupling means are defined by first and second outside diameters of said body.

18. A vibrator assembly in accordance with claim 12 wherein said body is generally annular and said first coupling means is defined by an outside diameter of said body and said second coupling means is defined by an inside diameter of said body, and wherein said outside diameter is less than said inside diameter.

9. A vibrator assembly in accordance with claim 12 wherein said body is generally annular and said first coupling means is defined by an outside diameter of said body and said second coupling means is defined by an inside diameter of said body, and wherein said outside diameter is greater than said inside diameter.

10. A vibrator assembly in accordance with claim 12 wherein said adaptor coupling further comprises a handle portion.

21. A vibrator assembly comprising:
a control handle;
a set of vibrator bodies each having a unique size or shape relative to other vibrator bodies of said set; and
a set of adaptor couplings adapted to selectively interconnect said control handle to said vibrator bodies on an interchangeable basis.

22. A vibrator assembly in accordance to claim 21 wherein said adaptor couplings each comprise:
a body;
a control handle end;
a vibrator body end;
a first coupling portion extending from said control handle end and adapted to removably connect to said control handle; and
a second coupling portion extending from at said vibrator body end and adapted to removably connect to one vibrator body of said set of vibrator bodies.

23. A method for preparing a vibrator control handle for use with one of a pair of first and second vibrator bodies of different size or shape, comprising the following steps performed in any suitable order:
selecting said first vibrator body for use;
determining whether said second vibrator body is mounted for use with said control handle, and if so, removing said second vibrator body from said control handle;
determining if said first vibrator body can be directly mounted to said control handle, and if not, selecting an adaptor coupling adapted to interconnect said first vibrator body to said control handle; and
connecting said adaptor coupling to said control handle and to said first vibrator body;
whereby said first vibrator body is interconnected to said control handle via said adaptor coupling for use.
